(19) United States
(12) Patent Application Publication
(10) Pub. No.: US 2019/0129004 A1
(43) Pub. Date: May 2, 2019

(54) RADAR SENSOR WITH DIGITAL SIGNAL PROCESSING UNIT

(71) Applicant: Infineon Technologies AG, Neubiberg (DE)

(72) Inventor: Herbert JAEGER, Linz (AT)

(73) Assignee: Infineon Technologies AG, Neubiberg (DE)

(21) Appl. No.: 16/170,924

(22) Filed: Oct. 25, 2018

(30) Foreign Application Priority Data
Oct. 26, 2017 (DE) 10 2017 125 171.5

(51) Int. Cl. G01S 7/35

(52) U.S. Cl. CPC G01S 7/352; G01S 2007/356

(57) ABSTRACT

A radar device includes a radar reception circuit configured to provide an analog radar signal by means of a radio frequency (RF) radar signal received by an antenna being downconverted into a baseband frequency. The radar reception circuit further includes an analog-to-digital converter, to which the analog radar signal is fed and which is configured to digitize said analog radar signal and to provide it as a digital radar signal, and also a digital multiplier configured to multiply the digital radar signal by a digital window signal, as a result of which a windowed radar signal is provided. A window generator is configured to calculate the digital window signal by evaluating one or more polynomials. The radar device further includes a processor configured to further process a plurality of signal blocks of the windowed radar signal, signal block by signal block.

### FIELD

The present description relates to the field of radar sensors and the associated digital radar signal processing.

### BACKGROUND

Radio-frequency (RF) transmitters and receivers are used in a multiplicity of applications, in particular in the field of wireless communication and radar sensors. In the automotive sector there is a growing demand for radar sensors that are used in so-called cruise control (Adaptive Cruise Control (ACC) or Radar Cruise Control) systems. Such systems can automatically adapt the speed of an automobile in order thus to maintain a safe distance from other automobiles traveling ahead (and also from other objects and from pedestrians). Further applications in the automotive sector are e.g. blind spot detection, lane change assist and the like.

Modern radar systems use large-scale integrated RF circuits that can combine all core functions of an RF frontend of a radar transceiver in a single housing (single-chip radar transceiver), which is often referred to as a monolithic microwave integrated circuit (MMIC). Such RF frontends usually include, inter alia, a voltage controlled oscillator (VCO) connected in a phase locked loop, power amplifiers (PAs), directional couplers and mixers and also associated control circuit arrangements for controlling and monitoring the RF frontend. The radar signals downconverted into the baseband are firstly preprocessed in analog form and finally digitized by means of an analog-to-digital converter (ADC). The analog preprocessing and ADC can also be integrated in the MMIC in which the RF frontend is also situated.

The subsequent digital processing of the radar signals usually takes place in a processor provided therefor, which is configured to detect, i.e. to localize, objects (so-called targets) situated in the radar channel from the digital radar signals. The processor can likewise be integrated in the MMIC or else in a separate chip. One object of the present invention could be considered that of making the implementation of the digital processing of the radar signals more efficient.

### SUMMARY

The object mentioned is achieved by means of a device as claimed in claim 1 and also by means of a method as claimed in claim 8. The dependent claims relate to various exemplary embodiments and further developments.

A radar device is described hereinafter. In accordance with one exemplary embodiment, the radar device includes a radar reception circuit configured to provide an analog radar signal by means of an RF radar signal received by an antenna being downconverted into a baseband. The radar reception circuit further includes an analog-to-digital converter, to which the analog radar signal is fed and which is configured to digitize said analog radar signal and to provide it as a digital radar signal, and also a digital multiplier configured to multiply the digital radar signal by a digital window signal, as a result of which a windowed radar signal is provided. A window generator is configured to calculate the digital window signal by evaluating one or more polynomials. The radar device furthermore includes a processor configured to further process the windowed radar signal block by block.

Furthermore, a method for a radar device is described. In accordance with one exemplary embodiment, the method includes the following: receiving an RF radar signal by an antenna, providing an analog radar signal by downconverting the RF radar signal into the baseband, providing a digital radar signal by digitizing the analog radar signal, windowing the digital radar signal with a digital window signal, wherein the digital window signal is calculated by evaluating at least one polynomial, and further processing the windowed radar signal block by block by means of a digital processor.

### BRIEF DESCRIPTION OF THE DRAWINGS

Exemplary embodiments are explained in greater detail below with reference to figures. The illustrations are not necessarily true to scale and the exemplary embodiments are not just restricted to the aspects illustrated. Rather, the main emphasis is placed on illustrating the principles underlying the exemplary embodiments. The figures show the following:

FIG. 1 is a schematic diagram for illustrating the functional principle of an FMCW radar system for distance and/or speed measurement;

FIG. 2 comprises two timing diagrams for illustrating the frequency modulation of the RF signal generated by the FMCW system;

FIG. 3 is a block diagram for illustrating the basic structure of an FMCW radar system;

FIG. 4 is a block diagram for illustrating one example of an analog RF frontend of the FMCW radar system from FIG. 3 with one reception channel;

FIG. 5 is a block diagram for illustrating one example of a digital signal processing chain for a radar channel;

FIG. 6 shows one exemplary implementation of the range/Doppler analysis in greater detail;

FIG. 7 shows a von Hann window with 1024 samples as an example of a window function;

FIG. 8 shows one exemplary implementation of a third-order polynomial by means of digital accumulators; and

FIG. 9 shows one exemplary embodiment of a window generator that can be used in the digital signal processing chain in accordance with FIG. 5.

### DETAILED DESCRIPTION

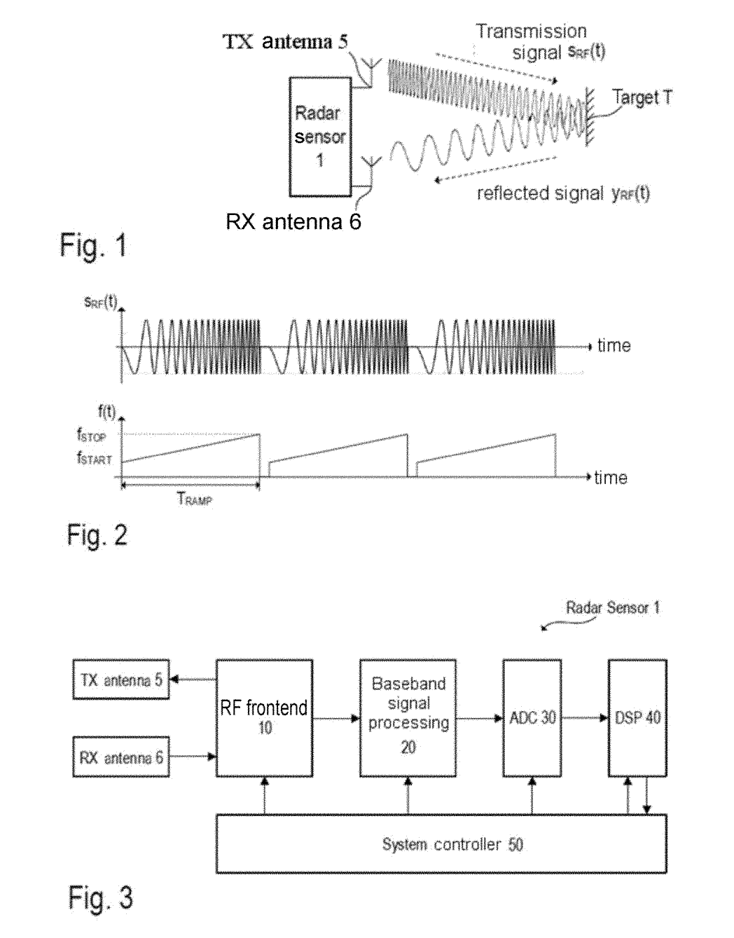

FIG. 1 illustrates the application of an FMCW radar system as sensor for measuring distances and speeds of objects, which are usually referred to as radar targets. In the present example, the radar device 10 comprises separate transmission (TX) and reception (RX) antennas 5 and 6 respectively (bistatic or pseudo-monostatic radar configuration). It should be noted, however, that a single antenna can also be used, which serves simultaneously as transmission antenna and as reception antenna (monostatic radar configuration). The transmission antenna 5 emits a continuous RF signal s_{RF}(t), which is frequency-modulated for example by means of a sawtooth signal (periodic, linear ramp signal). The emitted signal s_{RF}(t) is backscattered at the radar target T and the backscattered (reflected) signal y_{RF}(t) is received by the reception antenna 6. In order to keep the illustrations simple, only one transmission (TX) and one reception (RX) channel are illustrated in the examples shown here. However, modern frequency-modulated continuous-wave (FMCW) radar systems are often multi-input/multi-output (MIMO) systems comprising a plurality of TX and RX channels. A plurality of RX channels may be expedient for example in applications in which the distance and the azimuth angle of a radar target are intended to be measured. The azimuth angle corresponds to the angle of arrival (DOA, direction of arrival) of the radar signal reflected at the radar target.

FIG. 2 illustrates by way of example the abovementioned frequency modulation of the signal s_{RF}(t). As illustrated in FIG. 2, the signal s_{RF}(t) is composed of a quantity of “chirps”, i.e. signal s_{RF}(t) comprises a sequence of sinusoidal signal waveforms having rising (up-chirp) or falling (down-chirp) frequency (see upper diagram in FIG. 2). In the present example, the instantaneous frequency f(t) of a chirp beginning at a start frequency f_{START} rises within a time period T_{RAMP} linearly to a stop frequency f_{STOP} (see lower diagram in FIG. 2). Chirps of this type are also referred to as a linear frequency ramp. Three identical linear frequency ramps are illustrated in FIG. 2. It should be noted, however, that the parameters f_{START}, f_{STOP}, T_{RAMP} and also the pause between the individual frequency ramps can vary. The frequency variation also need not necessarily be linear. Depending on the implementation, it is also possible to use transmission signals having exponential (exponential chirps) or hyperbolic (hyperbolic chirps) frequency variation.

FIG. 3 is a block diagram which illustrates one possible structure of a radar device 1 (radar sensor) by way of example. Similar structures can e.g. also be found in RF transceivers that are used in other applications, such as e.g. wireless communication systems. Accordingly, at least one transmission antenna 5 (TX antenna) and at least one reception antenna 6 (RX antenna) are connected to an RF frontend 10, which can include all those circuit components which are required for the RF signal processing. Said circuit components comprise for example a local oscillator (LO), RF power amplifiers, low-noise amplifiers (LNA), directional couplers (e.g. Rat-Race couplers, circulators, etc.) and also mixers for downconverting the RF signals into the baseband or an intermediate frequency band (IF band). The RF frontend 10 can be integrated—if appropriate together with further circuit components into a monolithic microwave integrated circuit (MMIC). The example illustrated shows a bistatic (or pseudo-monostatic) radar system comprising separate RX and TX antennas. In the case of a monostatic radar system, a single antenna (or an antenna array) would be used both for emitting and for receiving the electromagnetic (radar) signals. In this case, a directional coupler (e.g. a circulator) can be used to separate the RF signals to be emitted into the radar channel from the RF signals (radar echoes) received from the radar channel.

In the case of a frequency-modulated continuous-wave radar system (FMCW radar system), the RF signals emitted via the TX antenna 5 can be e.g. in the range of approximately 20 GHz and 90 GHz (e.g. 77 GHz in some applications), but even higher frequency ranges can be used (e.g. type A ISM bands in the range of 122-123 GHz or 244-246 GHz). As mentioned, the RF signal received by the RX antenna 6 comprises the radar echoes, i.e. those signal components that are backscattered at the so-called radar targets. The received RF signal y_{RF}(t) is downconverted, e.g., into the baseband, and processed further in the baseband by means of analog signal processing (see FIG. 3, analog baseband signal processing chain 20). The analog signal processing mentioned substantially comprises a filtering and, if appropriate, an amplification of the baseband signal. The baseband signal is finally digitized (see FIG. 3, analog-to-digital converter 30) and processed further in the digital domain. The digitized signals (with regard to their origination) are also referred to as digital radar signals. The digital signal processing chain can be realized at least partly as software that is executed on at least one processor (see FIG. 3, DSP 40). The overall system is generally controlled by means of a system controller 50, which can likewise be implemented at least partly as software that can be executed on a processor such as e.g. a microcontroller. The RF frontend 10 and the analog baseband signal processing chain 20 (optionally also the analog-to-digital converter 30 and the DSP 40) can be jointly integrated in a single MMIC (i.e. one RF semiconductor chip). Alternatively, the individual components can also be distributed among a plurality of integrated circuits.

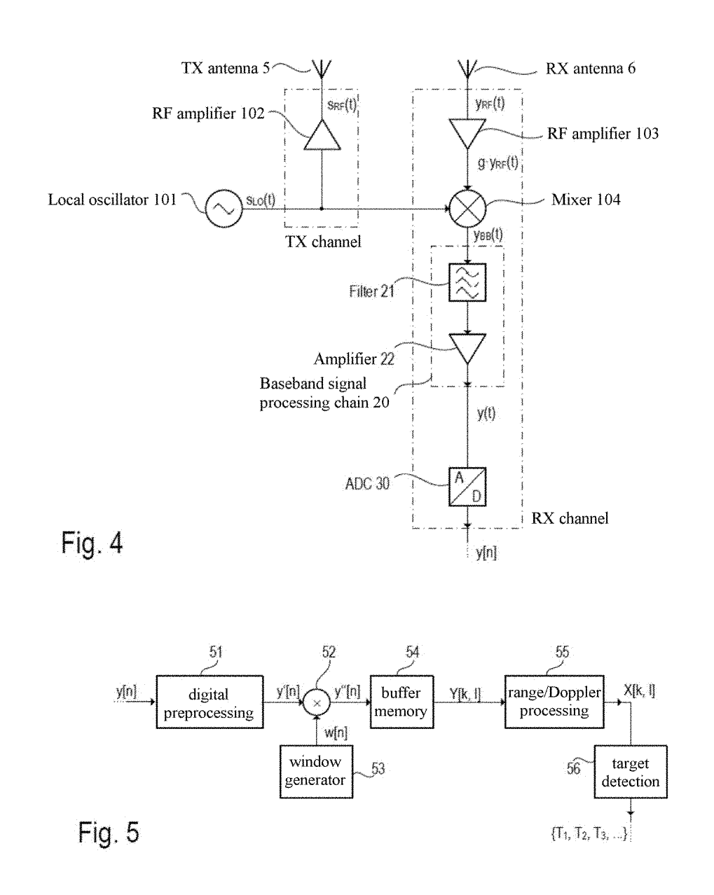

FIG. 4 illustrates one exemplary implementation of the RF frontend 10 with downstream baseband signal processing chain 20, which can be part of the radar sensor from FIG. 3. It should be noted that FIG. 4 illustrates a simplified circuit diagram in order to show the basic structure of a TX channel and an RX channel of a radar sensor. Actual implementations, which may be greatly dependent on the specific application, may be more complex, of course. The RF frontend 10 comprises a local oscillator 101 (LO), which generates an RF signal s_{LO}(t). The signal s_{LO}(t), as described above with reference to FIG. 3, can be frequency-modulated and, as mentioned, is referred to as LO signal. In radar applications, the LO signal is usually in the SHF (Super High Frequency, centimeter-wave) or in the EHF (Extremely High Frequency, millimeter-wave) band, e.g. in the interval of 75 GHz to 81 GHz in automotive applications. The local oscillator 101 can be embodied for example as a voltage controlled oscillator (VCO) that is connected in a phase locked loop (PLL). Instead of VCOs, digitally controlled oscillators (DCOs) can alternatively be used as well.

The LO signal s_{LO}(t) is processed both in the transmission signal path and in the reception signal path. The transmission signal s_{RF}(t) (cf. FIG. 2), which is emitted by the TX antenna 5, is generated by amplifying the LO signal s_{LO}(t), for example by means of the RF power amplifier 102. The output of the amplifier 102 can be coupled to the TX antenna 5 (in the case of a bistatic or pseudo-monostatic radar configuration). The reception signal y_{RF}(t), which is provided by the RX antenna 6, is fed to the RF port of the mixer 104. In the present example, the RF reception signal y_{RF}(t) (antenna signal) is preamplified by means of the amplifier 103 (gain g), and the amplified RF reception signal g y_{RF}(t) is fed to the mixer 104. The amplifier 103 can be e.g. an LNA (low-noise amplifier). The LO signal s_{LO}(t) is fed to the reference port of the mixer 104, such that the mixer 104 downconverts the (preamplified) RF reception signal y_{RF}(t) into the baseband. In the present example, the mixer 104 downconverts the preamplified RF reception signal g y_{RF}(t) (i.e. the amplified antenna signal) into the baseband. The mixing can be carried out in one stage (that is to say from the RF band directly into the baseband) or via one or more intermediate stages (that is to say from the RF band into an intermediate frequency band and on into the baseband).

The downconverted baseband signal (mixer output signal) is designated by y_{BB}(t) in the example illustrated. This baseband signal y_{BB}(t) is firstly processed further in analog form, wherein the analog baseband signal processing chain 20 substantially comprises an amplification (amplifier 22) and a filtering (e.g. bandpass filter 21) in order to suppress undesired sidebands and image frequencies. The baseband signal y(t) preprocessed in analog form is digitized, e.g. by means of the ADC 30, and the resulting digital radar signal y[n] is subsequently processed further in digital form (see e.g. FIG. 5).

FIG. 5 illustrates by way of example one possible implementation of the digital signal processing chain of a digital radar signal y[n]. In the case of a plurality of RX channels, the signal processing for the digital radar signal of each RX channel may be substantially identical. For the measurement of the arrival angle of a radar signal (direction of arrival, DOA), the phase differences of the radar signals of the individual channels are relevant. In accordance with FIG. 5, firstly a digital preprocessing of the radar signal y[n] takes place (see FIG. 5, digital preprocessing 51). Said digital preprocessing can comprise e.g. a digital filter, a sample rate conversion, etc. The preprocessed radar signal is designated by y′[n]. However, the digital preprocessing is optional and, depending on the implementation, can also be replaced by later signal processing steps (e.g. in the frequency domain).

With regard to a subsequent signal processing in the frequency domain, for which the radar signal y′[n] is transformed block by block into the frequency domain, a windowing of the radar signal y′[n] block by block is provided. To that end, the digital signal processing chain comprises a window generator 53, which generates a digital window signal w[k], and also a multiplier 52 configured to multiply the radar signal y′[n] by the window signal w[k]. That is to say that the windowed radar signal y″[n] is calculated in accordance with y″[n]=y′[n]·w[n mod N], wherein N is the length of the window signal w[k]. In other words, the time index k of the window signal w[k] runs only from 0 to N−1 and then starts again at 0. It goes without saying that the time index k=n mod N of the window signal is a mathematical abstraction and the regular repetition of the window signal can be implemented in various ways depending on the implementation. A suitable timing control can be implemented e.g. in the processor that carries out the digital signal processing (cf. FIG. 3, DSP 40), in the system controller 50, or in a separate digital circuit.

The windowed radar signal y″[n] thus comprises a plurality of segments of length N that were each multiplied by the window signal w[n mod N]. These segments (blocks) can be temporarily stored in a buffer memory 54 in order to enable the processing of the windowed radar signal y″[n] block by block. The window signal w[k] can represent an arbitrary suitable window, for example a von Hann window, a Hamming window, a Gaussian window, a cosine window, a Blackmann window, a Kaiser window, a Bartlett window, a Dolph-Chebyshev window, etc. The different types of window functions can be assessed on the basis of their properties in the frequency domain and generally differ in the width of the primary maximum (main lobe) and the absolute value of the secondary maxima (side lobes), which has e.g. effects on the achievable accuracy of a subsequent spectral analysis (e.g. on account of the leakage effect, leakage factor). The different window types and their advantages and disadvantages are known per se and will therefore not be discussed further here. The choice of a suitable window is an implementation detail and depends on the specific application. In the example from FIG. 5, the windowed signal y″[n] is subjected to a range/Doppler analysis (range/Doppler processing 55). In the range/Doppler analysis, a two-stage Fourier transformation is applied to a specific number of segments (blocks) of the windowed radar signal y″[n] (B is the number of blocks; each block comprises N samples). It goes without saying that the start times of the blocks must be synchronized with the frequency modulation of the LO signal. That is to say that a block of the windowed digital radar signal corresponds temporarily to a chirp in the emitted radar signal. The length of a block (number of samples) corresponds to the length N of the window signal w[k]. The Fourier transformation is usually implemented by the FFT algorithm (Fast Fourier Transform).

The individual blocks of the windowed radar signal y″[n] can be regarded as a matrix Y[k, l], wherein each row of the matrix represents a block of N samples of the windowed radar signal y″[n] (k=0, . . . , N−1 and 1=0, . . . B). This matrix Y[k, l] is Fourier-transformed row by row in a first stage (also called range FFT), and the result is referred to as a range map. In a second stage, the range map is Fourier-transformed column by column (also called Doppler FFT), and the so-called range/Doppler map X[k, l], which can likewise be written as N×B matrix, is obtained as a result. In the case of a plurality of RX channels, the range/Doppler maps of the individual RX channels can be combined to form a three-dimensional array, which is also referred to as a “radar data cube”. Said radar data cube includes the input data for various algorithms that can be used for the detection and classification of radar targets. The target detection algorithm is represented by the block 56 in FIG. 5.

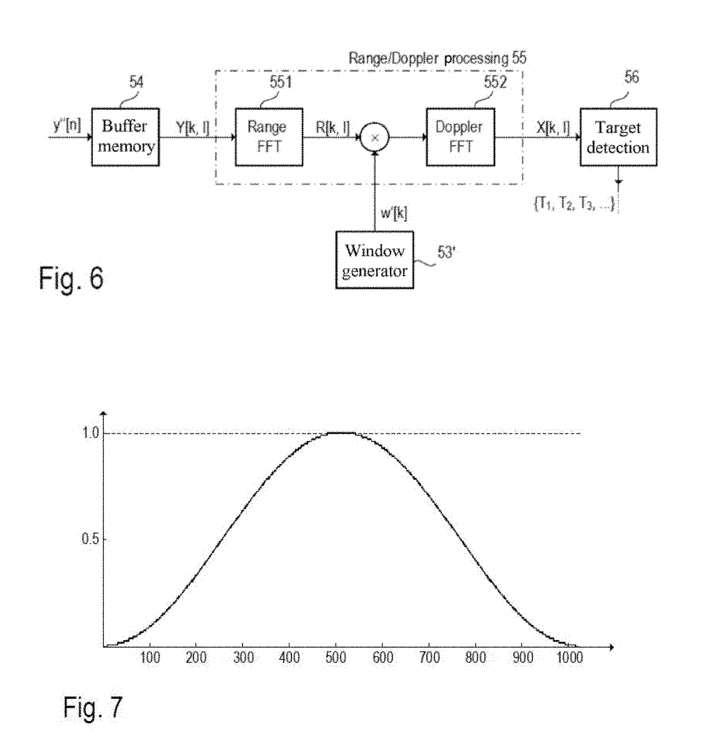

In accordance with FIG. 5, the windowing of the preprocessed radar signal y′[n] is carried out before the first Fourier transformation stage (range FFT) with the aid of the window generator described here. It goes without saying that a window generator of identical type can also be used before the second Fourier transformation stage (Doppler FFT) in order to influence the width of the primary maximum (main lobe) of the Doppler frequency and the secondary maxima (side lobes). One example of this is illustrated in FIG. 6. FIG. 6 essentially shows one exemplary implementation of the range/Doppler processing 55 from FIG. 5 in greater detail. During the processing of the windowed radar signal y″[n] block by block, a plurality of signal blocks are transformed in a plurality of transformation stages (e.g. range FFT, Doppler FFT) into the frequency domain, wherein a further windowing of the signal blocks to be transformed with the further digital window signal can be carried out between the individual transformation stages. In other words: the windowed radar signal y″[n] is processed block by block as mentioned by means of the corresponding matrix Y[k, l] having B rows (each row represents a segment/block of the windowed radar signal y″[n]) being Fourier-transformed row by row (range FFT 551). The result is the range map R[k, l] mentioned. The individual columns of the range map R[k, l] are subjected to a further windowing with the window function w′[k] before the second Fourier transformation stage (Doppler FFT 552). The associated function values are generated by a further window generator 53′, which operates substantially identically to the window generator 53 in the example from FIG. 5. The result of the second Fourier transformation stage is the range/Doppler map X[k, l] mentioned above.

In some applications, given identically formed arrangement of the (e.g. virtual) reception antennas along the third dimension of the radar data cube (corresponds to the radar channels), a Fourier transformation can be calculated in order to determine the direction of the radar target (angle spectrum). Use of the window generator described here is possible in this application, too.

FIG. 7 shows by way of example a von Hann window with 1024 samples (N=1024). This window is defined by w[k]=hav(2π·k/(N−1)), wherein hav( ) is the haversine function. Other types of window functions are likewise defined by transcendental functions that are numerically difficult to calculate. For this reason, in many implementations, precalculated values of a window function are stored in a memory. In order to reduce the required memory space during the digital radar signal processing, in the exemplary embodiments described here, the window function w[k] is approximated by one or more polynomials that can be calculated digitally using very simple means. Consequently, it is no longer necessary to store the individual samples of the window function, but rather just a few precalculated polynomial coefficients.

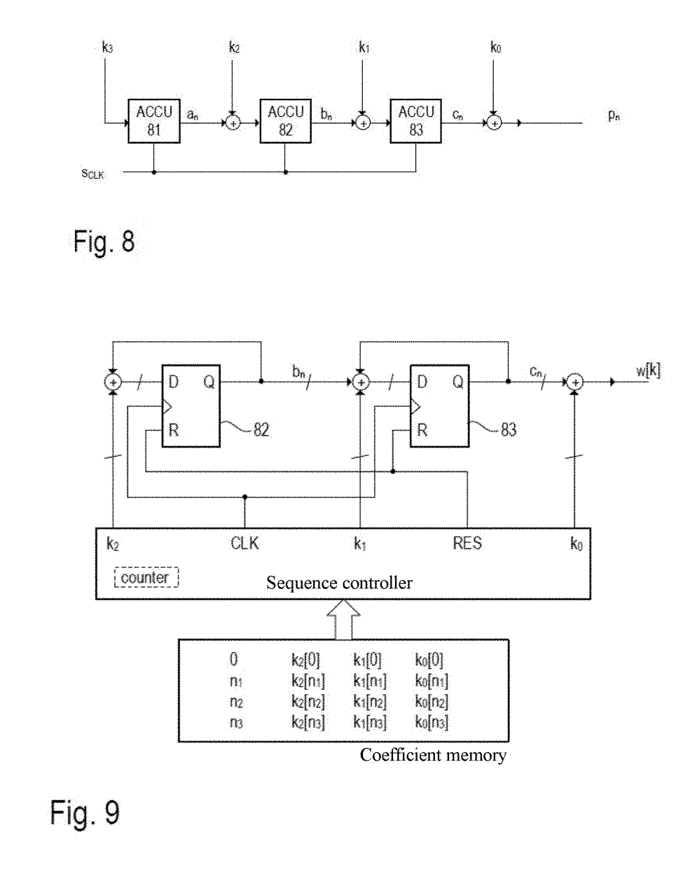

FIG. 8 illustrates, on the basis of an example, the generation of a third-order polynomial, which necessitates just three accumulators and three adders. In general, q accumulators and q adders are required for a q-th order polynomial. An accumulator implements the equation yₙ=yₙ₋₁+x (where y₀=0 for n=1, 2, . . . ) as a digital circuit, wherein yₙ is the state variable and simultaneously the output value of the accumulator and x is the input value. In each time step n→n+1, the output value of the accumulators is updated. The time steps (the clock cycle) are predefined by a clock signal s_{CLK}. In the example illustrated in FIG. 8, the accumulator 81 operates in accordance with the equation aₙ=aₙ₋₁+k₃ (where a₀=0), the accumulator 82 operates in accordance with the equation bₙ=bₙ₋₁+(aₙ+k₂) (where b₀=0), and the accumulator 83 operates in accordance with the equation cₙ=cₙ₋₁+(bₙ+k₁) (where c₀=0). The polynomial pₙ is obtained by addition of the last coefficient k₀. The values k₀, k₁, k₂, k₃ are constant coefficients. By means of a short calculation it is possible to show that the polynomial pₙ is defined by the coefficients k₀, k₁, k₂, k₃, wherein pₙ=(k₃/6) n³+(k₂−k₃)/2·n²+(k₃/3−k₂/2+k₁) n+k₀. The circuit from FIG. 5 is thus suitable for generating signals whose samples represent the function values of a third-order polynomial. The concept can easily be generalized to polynomials of arbitrary order.

In order to approximate a specific window function w[k] by a polynomial, the coefficients of an (e.g. quadratic) polynomial can be adapted such that an error value representing the deviation of the polynomial from the actual window function w[k] is minimized. The error value may depend on the optimization method used. With the use of the least mean square method (LMS method), the error value is e.g. equal to the sum of the error squares. An array of optimization methods that determine the error value in the time or frequency domain are known per se and will therefore not be explained further here. Taylor expansion of the window function can also lead to suitable polynomial coefficients.

In order additionally to improve the approximation, in accordance with one exemplary embodiment, a window function is not approximated as a whole, but rather piecewise. That is to say that the window function w[k] in the segments k=0, . . . n₁−1 (first segment), k=n₁, . . . n₂−1 (second segment), k=n₂, . . . n₃−1 (third segment) and k=n₃, . . . N−1 (fourth segment) is approximated by different polynomials. That is to say that a specific set of coefficients k₀, k₁, k₂, k₃ is calculated for each of the four segments. The decomposition into four segments is merely one example, and a different number of segments can also be used. Not only the coefficients of the polynomials but also the temporal position of the limits n₁, n₂ and n₃ between the segments can be optimized (e.g. by means of an LMS method).

FIG. 9 shows one exemplary embodiment of a window generator 53 that can be used efficiently as a digital circuit in the digital signal processing chain in accordance with FIG. 5. In the example illustrated, second-order polynomials are used for approximating a window function. The accumulators 82 and 83 are implemented by means of D latches, each of which can store a digital word having a specific word width (e.g. 12 bits). As in the example from FIG. 8, the accumulator 82 implements the sequence bₙ=bₙ₋₁+k₂ where b₀=0, and the accumulator 83 implements the sequence cₙ=cₙ₋₁+(bₙ₋₁+k₂) where c₀=0. The output signal, i.e. the window function w[k], is cₙ+k₀ (wherein n=k holds true in this case). The sequence controller 85 can be configured to provide a clock signal s_{CLK} that signals in each case the progress of the time index n. For this purpose, the sequence controller 85 can comprise a counter that increases the time index n from 0 to N−1 in steps. A reset can be triggered for example by an overflow of the counter (or by a superordinate controller). In the case of a reset, the accumulators 82 and 83 are reset to b₀=0 and c₀=0, respectively, and the time index n is reset to zero.

The coefficients k₀, k₁ and k₂ can be stored in a memory 86, which can be contained in the sequence controller 85. In the example illustrated, four different sets of coefficients k₀, k₁ and k₂ are used for four different segments of the window function. The coefficients k₀[0] k₁[0] and k₂[0] are used for the interval 0, . . . n₁−1, the coefficients k₀[n₁] k₁[n₁] and k₂[n₁] are used for the interval n₁, . . . n₂−1, the coefficients k₀[n₂] k₁[n₂] and k₂[n₂] are used for the interval n₂, . . . n₃−1, and the coefficients k₀[n₃] k₁[n₃] and k₂[n₃] are used for the interval n₃, . . . N−1. The switchover between the different sets of coefficients is accomplished by the sequence controller 85.

An approximation of the window function w[k] by means of second-order polynomials is possibly too inaccurate in practice, but the error becomes negligibly small with third- or fourth-order polynomials. The implementation in accordance with the example from FIG. 9 is possible as a digital circuit with only a few and simple circuit components and storage of all (e.g. 1024) samples of the window function is avoided.

Although exemplary embodiments have been described and illustrated with reference to one or more implementations, changes and/or modifications can be made to the examples illustrated, without departing from the spirit and scope of the appended claims. Particularly with regard to the various functions implemented by the above-described components or structures (units, assemblies, devices, circuits, systems, etc.), the designations (including the reference to a “means”) used to describe such a component are also intended to correspond to any other component or structure that implements the specified function of the described component (i.e. that is functionally equivalent), even if it is not structurally equivalent to the disclosed structure that implements the function in the exemplary implementations illustrated here.

What is claimed is:

1. A radar device, comprising:
a radar reception circuit configured to provide an analog radar signal by downconverting a radio frequency (RF) radar signal received by an antenna into a baseband frequency;
an analog-to-digital converter, to which the analog radar signal is fed, and which is configured to digitize the analog radar signal into a digital radar signal;
a digital multiplier configured to multiply the digital radar signal by a digital window signal, as a result of which a windowed radar signal is provided, the windowed radar signal comprising a plurality of signal blocks;
a window generator configured to calculate the digital window signal by evaluating one or more polynomials; and
a processor configured to further process the plurality of signal blocks of the windowed radar signal, signal block by signal block.

2. The radar device as claimed in claim 1, further comprising:
a buffer memory for storing the plurality of signal blocks of the windowed radar signal, wherein the stored plurality of signal blocks of have a block length corresponding to a length of the digital window signal.

3. The radar device as claimed in claim 1, wherein:
the window generator comprises a plurality of accumulator circuits connected in series, and
the output of each accumulator circuit of the plurality of accumulator circuits is coupled to a different adder of a plurality of adders, wherein each of the plurality of adders is configured to add a constant coefficient to an output value of a respective accumulator circuit.

4. The radar device as claimed in claim 3, wherein each of the plurality of signal blocks as a block length, and the window generator comprises a sequence controller configured to feed a clock signal to the plurality of accumulator circuits and to reset the plurality of accumulator circuits after a number of clock cycles corresponding to the block length.

5. The radar device as claimed in claim 1, wherein the window generator, for calculating the digital window signal, uses respectively different polynomials in different temporal segments of the digital window signal.

6. The radar device as claimed in claim 1, wherein the processor is configured to sequentially transform the plurality of signal blocks of the windowed radar signal into a frequency domain, the plurality of signal blocks being stored in a buffer memory.

7. The radar device as claimed in claim 1, further comprising:
a further window generator configured to calculate a further digital window signal by evaluating one or more polynomials,
wherein the processor is configured to transform the plurality of signal blocks in a plurality of transformation stages into a frequency domain during the processing of the windowed radar signal, signal block by signal block, and
wherein the processor is configured to perform a further windowing of the plurality of signal blocks of the windowed radar signal with the further digital window signal, wherein the further windowing of the plurality of signal blocks is carried out between a first transformation stage and a second transformation stage of the plurality of transformation stages.

8. A method, comprising:
receiving a radio frequency (RF) radar signal by an antenna;
providing an analog radar signal by downconverting the RF radar signal into a baseband frequency;
providing a digital radar signal by digitizing the analog radar signal;
windowing the digital radar signal with a digital window signal, wherein the digital window signal is calculated by evaluating at least one polynomial, and the windowed radar signal comprises a plurality of signal blocks; and
processing the plurality of signal blocks of the windowed radar signal, signal block by signal block, by means of a digital processor.

9. The method as claimed in claim 8, further comprising:
buffering the plurality of signal blocks of the windowed radar signal, wherein the plurality of signal blocks have a block length corresponding to a length of the digital window signal.

10. The method as claimed in claim 8, wherein, for calculating the digital window signal, different polynomials are used in different temporal segments of the digital window signal, respectively.

11. The method as claimed in claim 8, wherein:
evaluating the at least one polynomial is carried out by means of a plurality of accumulator circuits connected in series, and
each accumulator circuit of the plurality of accumulator circuits has an output value to which a constant coefficient is added.

12. The method as claimed in claim 11, wherein the digital window signal is subdivided into a plurality of temporal segments and the constant coefficients are updated after an end of a temporal segment.

13. The method as claimed in claim 8, wherein the processing of the plurality of signal blocks of the windowed radar signal comprises carrying out a transformation into the frequency domain of each of the plurality of signal blocks of the windowed radar signal.
